(19) United States
(12) Patent Application Publication
(10) Pub. No.: US 2024/0136540 A1
(43) Pub. Date: Apr. 25, 2024

(54) METHOD FOR PRODUCING CATALYST LAYERS FOR FUEL CELLS

(71) Applicant: Robert Bosch GmbH, Stuttgart (DE)

(72) Inventors: Marcus Wegner, Leonberg (DE); Ken Jenewein, Muenster (DE); Markus Widenmeyer

(21) Appl. No.: 18/547,040

(22) PCT Filed: Jan. 24, 2022
(86) PCT No.: PCT/EP2022/051435

§ 371 Date: Aug. 17, 2023

(30) Foreign Application Priority Data
Feb. 18, 2021 (DE) 10 2021 201 540.9

(51) Int. Cl. H01M 4/88; H01M 4/90; H01M 4/92

(52) U.S. Cl. CPC H01M 4/8828; H01M 4/8882; H01M 4/9016; H01M 4/921

(57) ABSTRACT

The invention relates to a method for producing a catalyst material (47) comprising catalytically active nanoparticles (47), in particular for electrodes (7, 8, 45) with catalyst layers (30) as catalysts for a fuel cell (2), having the steps of: providing (52) a first starting material comprising a first metal, providing (53) a second starting material comprising a second metal, mixing the first starting material and the second starting material in order to form a reactant material, and thermally treating (56) the reactant material so that catalytically active nanoparticles (47) are produced from the first starting material and the second starting material and the first and second metal are connected together in order to at least partly form an alloy of the first and second metal in the catalytically active nanoparticles (47) such that catalytically active nanoparticles (47) are produced as an intermediate material comprising the alloy of the first and second metal. The content of the second metal and/or the second starting material on the surface (48) of the catalytically active nanoparticles (47) is reduced in the intermediate material so that a product material is produced from the intermediate material as the catalyst material (47).

### BACKGROUND

The present invention relates to a method for producing catalyst material, a method for producing catalyst layers, a fuel cell unit, and a method for producing a fuel cell unit.

Fuel cell units acting as galvanic cells convert continuously supplied fuel and oxidizer into electrical energy and water by means of redox reactions on an anode and cathode. Fuel cells are used in a wide variety of stationary and mobile applications, e.g., in homes without connection to a power grid or in motor vehicles, rail transport, aviation, space travel, and marine applications. In fuel cell units, a plurality of fuel cells are stacked on top of one another in a stack.

During the manufacture of a fuel cell unit from layered components, in particular membrane electrode assemblies, gas diffusion layers, and bipolar plates, these are stacked into fuel cells, and the fuel cells are stacked into the fuel cell unit. The membrane electrode assemblies comprise layered proton exchange membranes with a layered anode and a layered cathode, and a layered catalyst layer on each of the anode and cathode.

The layered catalyst layers are formed by carrier layers to which catalytically active nanoparticles are attached. The catalytically active nanoparticles are, e.g., produced from precursors as a first starting material with platinum as a first metal in a compound and a second starting material with tungsten as a second metal as tungsten oxide WO₃. The catalytically active nanoparticles are designed as an alloy of the first metal, i.e., platinum, and the second metal, i.e., tungsten. At the surface of the catalytically active nanoparticles, a proportion of tungsten oxide remains, reducing the catalytic effect. For the application of fuel cell units in motor vehicles, the highest possible power per unit area of the anodes and cathodes with the catalyst layers is needed in order for the fuel cell unit to require little installation space and mass per power kW. The power per unit area of the anodes and cathodes with the catalyst layers is greater when the catalytic effect of the catalyst layers is higher, and vice versa. Therefore, the catalyst layers with the catalytically active nanoparticles whose surfaces contain a substantial amount of tungsten oxide have only a moderate level of catalytic activity, which can be improved for automotive applications.

### SUMMARY

A method according to the invention for producing catalyst material comprising catalytically active nanoparticles, in particular for electrodes with catalyst layers as catalysts for a fuel cell, with the following steps: providing a first starting material comprising a first metal, providing a second starting material comprising a second metal, preferably providing a carrier material for the adhesion of catalyst material, mixing the first starting material and the second starting material and preferably the carrier material to form a reactant material, thermally treating the reactant material so that catalytically active nanoparticles are produced from the first starting material and second starting material and the first and second metals are at least partially bonded together to form catalytically active nanoparticles with the alloy of the first and second metals as intermediate material, so that catalytically active nanoparticles are produced with the alloy of the first and second metals as an intermediate material, wherein, in the intermediate material, the proportion of the second metal and/or of the second starting material on the surface of the catalytically active nanoparticles is reduced, so that a product material is produced as the catalyst material from the intermediate material. The term “material” is a generic term referring to a pure material and a mixture, so that the reactant material, the intermediate material and the product material can be pure materials as well as mixtures. The first starting material comprises the first metal, which regarding the term “comprising” signifies that the first starting material comprises only the first metal or additionally at least one further material, which also applies in a similar manner the term “comprising” regarding other materials and/or components in the present patent application.

In an additional embodiment, on the surface of the catalytically active nanoparticles, the proportion of the second metal and/or the second starting material is reduced with a fluid, in particular a liquid, by flushing the intermediate material with the fluid, in particular the liquid, so that the second metal and/or the second starting material is taken up, in particular dissolved in the fluid, in particular the liquid, and removed from the intermediate material due to the flow of the fluid. The intermediate material is preferably present as a dried powder or as a solution.

Preferably, the pH level of the fluid is greater than 7, 9, or 11.

In a further embodiment, the fluid comprises sodium hydroxide and/or potassium hydroxide and/or ammonia and/or tetramethyl ammonium hydroxide and/or alcohol and/or water.

In a further embodiment, the proportion of the second metal and/or the second starting material is reduced by at least 20%, 30%, 50%, 70% or 90% on the surface, in particular the surface layer, of the catalytically active nanoparticles; in particular by at least 20 vol. %, vol.-30%, 50 vol. %, 70 vol. % or 90 vol. % or at least 20 mass-%, 30 mass-%, 50 mass-%, 70 mass-% or 90 mass-% or at least 20 material amount-%, 30 material amount-%, 50 material amount-%, 70 material amount-% or 90 material amount-%.

In an additional embodiment, following the thermal treatment of the intermediate material, after the catalytically active nanoparticles are produced and while the amount of the second metal and/or the second starting material on the surface of the catalytically active nanoparticles is reduced, the amount of the second metal and/or the second starting material inside the catalytically active nanoparticles is maintained at substantially constant levels. The phrase “maintained at substantially constant levels” preferably means that the volume or mass or material amount of the portion of the second metal and/or the second starting material inside the nanoparticles changes by less than 20%, 10%, 5%, or 3%.

After reducing the amount of the second metal and/or the second starting material on the surface of the catalytically active nanoparticles, the product material is advantageously subjected to an additional thermal treatment.

In a supplementary variant, during the additional thermal treatment, the product material with the catalytically active nanoparticles is at a temperature between 100° C. and 1200° C., in particular between 200° C. and 800° C.

Preferably, during the additional thermal treatment, the product material with the catalytically active nanoparticles is exposed to a process gas, in particular a process gas as a reducing agent, preferably hydrogen.

In a further embodiment, the first starting material comprises a chemical compound as a precursor with the first metal and at least one other chemical element, in particular hydrogen and/or oxygen and/or nitrogen and/or chlorine, preferably as a salt or a complex with the first metal, in particular H₂PtCl₆ or Pt(NO₃)₂), preferably as a solution, wherein a solution is preferably also understood to refer to a suspension.

In a supplementary embodiment, the second starting material is designed as metal oxide nanoparticles from a compound between a second metal and oxygen, in particular as a solution with the metal oxide nanoparticles, and/or as a solution, in particular a solution with alcohol, with a salt with the second metal and/or as a solution, in particular a solution with alcohol, as a complex with the second metal, wherein a solution is preferably also understood to refer to a suspension.

In a further variant, the first metal is a noble metal, in particular palladium (Pd), and/or a platinum metal, in particular platinum (Pt) and/or rhodium (Rh) and/or ruthenium (Ru) and/or iridium (Ir) and/or osmium (Os), and/or the second metal is a transition metal, in particular of the chromium group, preferably chromium (Cr) and/or molybdenum (Mo) and/or tungsten (W).

The method according to the invention for producing catalyst layers, in particular electrodes with catalyst layers for fuel cells of a fuel cell unit, comprises the following steps: providing catalyst material comprising catalytically active nanoparticles, providing carrier layers for adhesion of catalyst material, applying the catalyst material to the carrier layers so that the catalyst material adheres to the carrier layers and catalyst layers are produced from the carrier layers, the catalyst material being provided by performing a method described in the present patent application.

The fuel cell unit according to the invention acting as a fuel cell stack for electrochemical generation of electrical energy comprises stacked fuel cells, the fuel cells each comprising a proton exchange membrane, an anode and a cathode, the anode and/or cathode each comprising a catalyst layer with catalytically active nanoparticles with an alloy of a first and second metal, a bipolar plate and gas diffusion layers, whereby the proportion, in particular the substance amount and/or mass amount and/or volume amount, of the second metal and/or of the second starting material on the surface of the catalytically active nanoparticles is greater, in particular at least 5%, 10%, 20% or 30% greater, than in the interior of the nanoparticles and/or the anode and/or cathode as [an] electrode is produced by a method described in this patent application and/or the catalyst layers are produced by a method described in the present patent application. Fuel cells comprising these catalyst layers have a high electrical output per unit area of the electrodes and/or catalyst layers, due to the high catalytic effects of the nanoparticles.

A method according to the invention for producing a fuel cell unit as a fuel cell stack for the electrochemical generation of electrical energy comprises the following steps: providing components of fuel cells, i.e., anodes, cathodes, proton exchange membranes, gas diffusion layers and bipolar plates, in which case the anodes and/or cathodes each comprise a catalyst layer with catalytically active nanoparticles with an alloy of a first and second metal; connecting the components of the fuel cells, i.e., anodes, cathodes, proton exchange membranes, gas diffusion layers and bipolar plates, to the fuel cells; stacking the fuel cells so that a fuel cell unit is formed, in which case the proportion, in particular the molar fraction and/or mass fraction and/or volume fraction, of the second metal and/or of the second starting material on the surface of the catalytically active nanoparticles is greater, in particular at least 5%, 10%, 20% or 30% greater, than in the interior of the nanoparticles; and/or the catalyst layers are provided by performing a method described in the present patent application.

In a supplementary embodiment used to produce the catalyst material, the carrier material for adhesion of catalyst material is provided and/or the first starting material, second starting material and carrier material are mixed to form the reactant material. The reactant material thereby additionally comprises the carrier material, such that the carrier material is also thermally treated during thermal treatment. Preferably, an adhesion of the first and/or second starting material and/or the catalyst material to the carrier material is performed. The adhesion to the carrier material supports and/or enables the formation of the nanoparticles from the alloy.

Preferably, the carrier material consists of a carbon powder, preferably with a particle size between 10 nm and 80 nm, in particular between 20 nm and 40 nm.

In a supplementary embodiment, the carrier material is Al₂O₃, TiO₂ or ZrO₂,

In an additional embodiment, the catalyst material is provided for the production of catalyst layers by providing the powdered catalyst material as the product material to which at least one further substance, preferably comprising a fluid, is added and mixed, such that the catalyst material is present as a slurry, and the catalyst material is applied to the carrier layers as a slurry; and the at least one further material preferably consists of water and/or alcohol and/or an ionomer.

In a further variant, the catalyst material is applied to the carrier layers in a solution as a product material.

In a further variant, an adhesion of the product material to the carrier layer is performed after the product material has been applied to the carrier layer.

In a further variant, the application of the product material to the carrier layer is performed by coating and/or impregnating the carrier layer with the product material, in particular using wet chemical coating and/or impregnation.

In a supplementary variant, the first metal and second metal are different metals.

Preferably, the first and/or second starting material is present as a solution.

In a supplementary variant, during the thermal treatment of the reactant material, the reactant material and/or the intermediate material have a temperature between 400° C. and 1800° C., in particular between 500° C. and 1500° C.

In a further variant, after mixing the first starting material, second starting material and preferably the carrier material into the reactant material and prior to thermally treating the reactant material, the reactant material is dried, so that the reactant material is preferably present as a powder or particulate reactant material without a fluid before and during thermal treatment.

In a further variant, drying is performed at a temperature between 20° C. and 120° C., in particular between 30° C. and 80° C.

In a supplementary variant, during thermal treatment of the reactant material, the reactant material and/or the intermediate is exposed to a process gas, in particular a process gas as a reducing agent, preferably hydrogen.

The electrodes with a catalyst layer advantageously comprise electrically conductive materials, in particular metals, outside the catalyst layer on the carrier layer to form the electrodes.

The carrier layer is preferably at least partially made of carbon.

In a further embodiment, the surface of the carrier layer is greater than 1 m²/g or 10 m²/g or 50 m²/g.

In a further variant, the mass amount of the first metal in the first starting material is between 0.1% and 30%.

In a further variant, the mass amount of the second metal in the second starting material is between 0.1% and 30%.

In a further embodiment, the first and/or second starting material comprises solvents, preferably water, and/or alcohols, and/or esters, and/or diols, and/or carboxylic acids, and/or amines.

Preferably, the product material is applied to the carrier layer as a slurry.

The surface layer advantageously comprises a layer thickness of between 1% and 30%, in particular between 3% and 20% of the diameter of the nanoparticles.

In a supplementary embodiment, following the reduction of the proportion of the second metal and/or following the reduction of the proportion of the second starting material, the proportion of the first metal on the surface of the catalytically active nanoparticles is between 100% and 50%, and the proportion of the second metal on the surface of the catalytic active nanoparticles is between 0% and 50%, wherein the sum of the proportion of the first and second metal on the surface of the catalytic particles is between 90% and 100%, and wherein the proportion preferably consists of a material proportion or mass proportion or volume proportion.

In a further embodiment, the electrodes are formed from a support layer with noble metal-containing carbon particles and microporous carbon fiber, glass fiber or plastic mats; the noble metal-containing carbon particles are preferably bonded to PTFE (polytetrafluoroethylene), FEP (fluorinated ethylene-propylene copolymer), PFA (perfluoroalkoxy), PVDF (polyvinylidene fluoride) and/or PVA (polyvinyl alcohol) and preferably hot-pressed with the microporous carbon fiber, glass fiber, or plastic mats.

The catalyst layers are advantageously formed from a carrier layer containing carbon particles and microporous carbon fiber, glass fiber or plastic mats; herein the carbon particles are preferably bonded to PTFE (polytetrafluoroethylene), FEP (fluorinated ethylene-propylene copolymer), PFA (perfluoroalkoxy), PVDF (polyvinylidene fluoride) and/or PVA (polyvinyl alcohol) and preferably hot-pressed with the microporous carbon fiber, glass fiber or plastic mats, and the catalytically active nanoparticles are attached and/or adhered to the support layer.

Preferably, the electrodes at least partially, in particular completely, form the catalyst layers. The greater the layer thickness of the catalytically active nanoparticles deposited and/or adhered in the carrier layers of the electrodes, the greater the layer thickness of the catalyst layer in the electrodes, and vice versa.

In a further variant, the carrier layer is provided as a plate and/or wafer, such that catalyst layers are produced on plates and/or wafers, in particular on electrodes. Electrodes as metal plates, e. g. copper, can thereby be coated with the catalyst material.

In a further embodiment, at least one further substance, in particular water and/or alcohol, is added to the reactant material prior to the thermal treatment of the reactant material, so that the reactant material consists of a solution and/or suspension; herein the first starting material, the second starting material and preferably the carrier material are preferably mixed to form a reactant material by adding the at least one further material prior to mixing the first starting material, second starting material and preferably the carrier material.

In a supplementary variant, the catalytically active nanoparticles in the catalyst material have a diameter between 1.5 nm and 4.0 nm, in particular between 2 nm and 3 nm.

In a further embodiment, the catalyst layers are designed be planar or in the shape of curved plates.

In a further embodiment, the catalyst layers consist of additional layers on the anodes and/or cathodes.

Preferably, the catalyst layers and anodes and/or cathodes form a common layer. The catalyst layers are thereby integrated into the anodes and/or cathodes as mixed layers, i.e., an additional catalyst material, i.e., nanoparticles, is present in the anodes and/or cathodes.

Fuel cell system according to the invention, in particular for a motor vehicle, comprising a fuel cell unit as a fuel cell stack with fuel cells, a compressed gas storage unit for storing gaseous fuel, a gas conveying device for conveying a gaseous oxidizing agent to the cathodes of the fuel cells, wherein the fuel cell unit is designed as a fuel cell unit described in this patent application.

In a supplementary variant, the components of the fuel cells and/or the fuel cells of the fuel cell unit are arranged so as to be stacked in alignment, in particular one above the other.

In a further embodiment, the fuel cell unit comprises a housing and preferably a storage plate. The housing and preferably the storage plate preferably bound an inner space. In particular, the fuel cell stack is arranged within the inner space.

In a further variant, the fuel cell unit comprises at least one connection device, in particular multiple connection devices, and tensioning elements.

Advantageous components for fuel cells include membrane electrode assemblies, proton exchange membranes, anodes, cathodes, catalyst layers, gas diffusion layers, and bipolar plates.

In a further embodiment, the connection device is designed as a bolt and/or is rod-shaped and/or is designed as a tensioning belt.

The tensioning elements are advantageously designed as clamping plates.

In a further variant, the gas conveying device is designed as a blower and/or a compressor and/or pressurized vessel with oxidizer.

In particular, the fuel cell unit comprises at least 3, 4, 5 or 6 connection devices.

In a further embodiment, the tensioning elements are plate-shaped and/or disc-shaped and/or planar and/or designed as a grid.

Preferably, the fuel is hydrogen, hydrogen-rich gas, reformate gas, or natural gas.

Advantageously, the fuel cells are substantially planar and/or disc-shaped.

In a supplementary variant, the oxidizer is air with oxygen or pure oxygen.

Preferably, the fuel cell unit is a PEM fuel cell unit with PEM fuel cells.

### BRIEF DESCRIPTION OF THE DRAWINGS

Exemplary embodiments of the invention are explained in greater detail hereinafter with reference to the accompanying drawings. Shown are:

FIG. 1 a highly simplified exploded view of a fuel cell system with components of a fuel cell,

FIG. 2 a perspective view of a portion of a fuel cell,

FIG. 3 a longitudinal section through a fuel cell,

FIG. 4 a perspective view of a fuel cell unit as a fuel cell stack, i.e. a fuel cell stack,

FIG. 5 a section through the fuel cell unit according to FIG. 4,

FIG. 6 a perspective view of a membrane electrode assembly,

FIG. 7 a perspective view of an anode and cathode as an electrode,

FIG. 8 a section through a nanoparticle, and

FIG. 9 a highly schematic representation of method steps for performing the method of producing the catalyst material.

### DETAILED DESCRIPTION

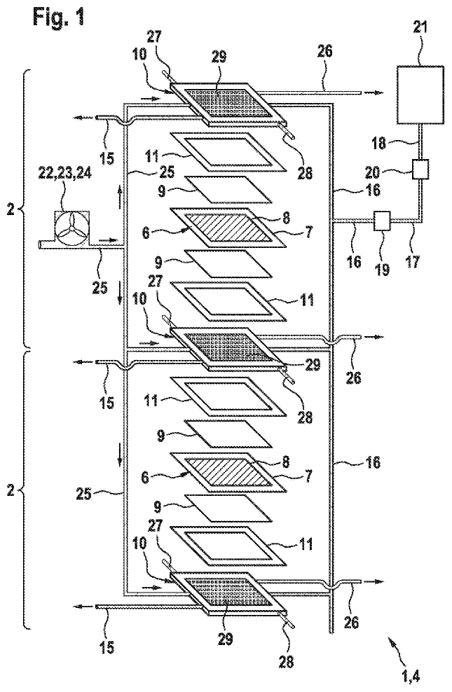

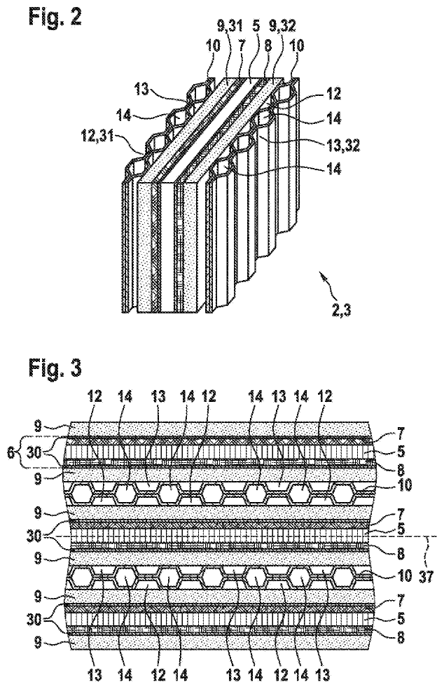

In FIGS. 1 to 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air provides the necessary gaseous oxidant. A reduction (electron uptake) takes place on the cathode 8. The oxidation as electron output is performed at the anode 7.

The redox equations of the electrochemical processes are as follows:

### Cathode:

O₂+4H⁺+4e⁻-»2H₂O

### Anode:

2H₂-»4H⁺+4e⁻

### Summed Reaction Equation of Cathode and Anode:

2H₂+O₂-»2H₂O

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation with larger currents, voltages between 0.5 V and 1.0 V are achieved. The series circuit of multiple fuel cells 2, in particular a fuel cell unit 1 as a fuel cell stack 1 of multiple fuel cells 2 arranged one above the other, has a higher voltage, which corresponds to the number of fuel cells 2 multiplied by the single voltage of a respective fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen Hz, i.e., it blocks the flow of oxygen O₂ and hydrogen Hz between a gas space 31 at the anode 7 with fuel hydrogen Hz and the gas space 32 at the cathode 8 with air and Oxygen O₂ as oxidizers. The proton conductivity of the PEM 5 increases with increasing temperature and increasing water content.

On the two sides of the PEM 5, each facing the gas spaces 31, 32, the electrodes 7, 8 are located as the anode 7 and cathode 8. A unit consisting of the PEM 5 and anode 7 as well as cathode 8 is referred to as a membrane electrode assembly 6 (MEA). The electrodes 7, 8 are pressed together with the PEM 5. The electrodes 6, 7 are platinum-containing carbon particles bonded to PTFE (polytetrafluorethylene), FEP (fluorinated ethylene-propylene copolymer), PFA (perfluoroalkoxy), PVDF (polyvinylidene fluoride), and/or PVA (polyvinyl alcohol) and hot-pressed in microporous carbon fiber, glass fiber, or plastic mats. A catalyst layer 30 is typically applied to the electrodes 7, 8 on the side towards the gas spaces 31, 32. The catalyst layer 30 at the gas space 31 with fuel at the anode 7 comprises nanoparticles 47 with a first and second metal alloy that are, respectively, bonded and adhered to a carrier layer 46. For example, the carrier layer 46 comprises graphitized soot particles bonded to a binder. The catalyst layer 30 on the gas space 32 with the oxidizer on the cathode 8 is structured analogously. For example, binders may consist of Nafion® as an ionomer, a PTFE emulsion, or polyvinyl alcohol. Preferably, the electrodes 7, 8, 45 and the catalyst layers 30 are formed from an identical carrier layer 46.

A gas diffusion layer 9 (GDL) is located on the anode 7 and cathode 8. The gas diffusion layer 9 at the anode 7 evenly distributes the fuel from channels 12 for fuel to the catalyst layer 30 at the anode 7. The gas diffusion layer 9 on the cathode 8 evenly distributes the oxidizer from channels 13 for oxidizer onto the catalyst layer 30 at the cathode 8. The GDL 9 also withdraws reaction water counter to the direction of flow of the reaction gases. Furthermore, the GDL 9 keeps the PEM 5 moist and conducts the power. For example, the GDL 9 is constructed from a hydrophobized carbon paper and a bonded layer of carbon powder.

A bipolar plate 10 lies atop the GDL 9. The electrically conductive bipolar plate 10 serves as a current collector, for diverting water, for conducting the reaction gases through a channel structure 29 and/or a flow field 29, and for dissipating the waste heat, which occurs in particular in the exothermic electrochemical reaction on the cathode 8. To dissipate the waste heat, channels 14 for passing a liquid or gaseous coolant are worked into the bipolar plate 10. The channel structure 29 on the gas space 31 for fuel is formed by channels 12. The channel structure 29 on the gas space 32 for oxidizers is formed by channels 13. For example, metal, conductive plastics, and composites or graphite are used as the material for the bipolar plates 10. The bipolar plate 10 thus comprises the three channel structures 29 formed by the channels 12, 13, and 14 for separately passing fuel, oxidizer, and coolant.

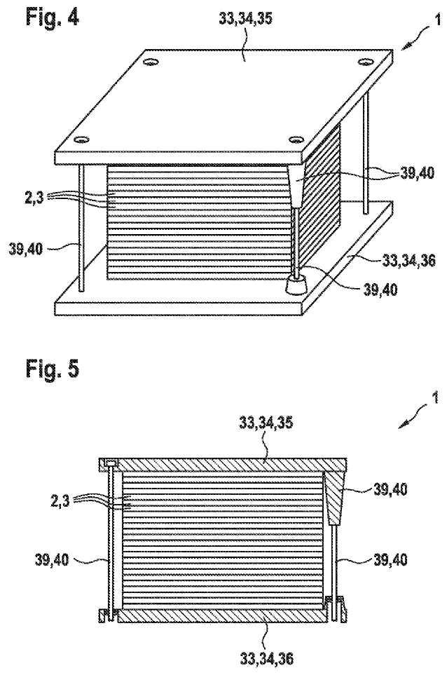

In a fuel cell unit 1 and/or a fuel cell stack 1 and/or a fuel cell stack 1, multiple fuel cells 2 are arranged so to as to be stacked in alignment (FIGS. 4 and 5). An exploded view of two stacked fuel cells 2 is depicted in FIG. 1. A seal 11 seals the gas spaces 31, 32 in a fluidically sealed manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure conduit 18 to a pressure reducer 20 in order to reduce the pressure of the fuel in a medium pressure conduit 17 of about 10 bar to 20 bar. From the medium pressure conduit 17, the fuel is conducted towards an injector 19. At the injector 19, the pressure of the fuel is reduced to an injection pressure of between 1 bar and 3 bar. From the injector 19, the fuel is supplied to a fuel supply line 16 (FIG. 1) and from the supply line 16 to the fuel channels 12 forming the channel structure 29 for fuel. As a result, the fuel passes through the gas space 31 for the fuel. The gas space 31 for the fuel is formed by the channels 12 and the GDL 9 at the anode 7. After passing through the channels 12, the fuel not consumed in the redox reaction at the anode 7 (and optionally water) are discharged from a controlled humidification means of the anode 7 via a discharge line 15 from the fuel cells 2.

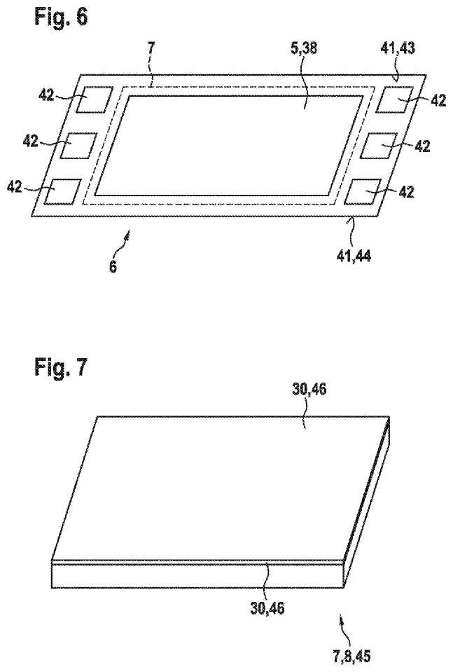

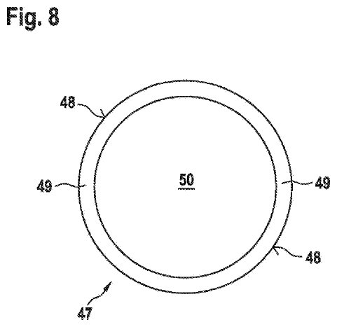

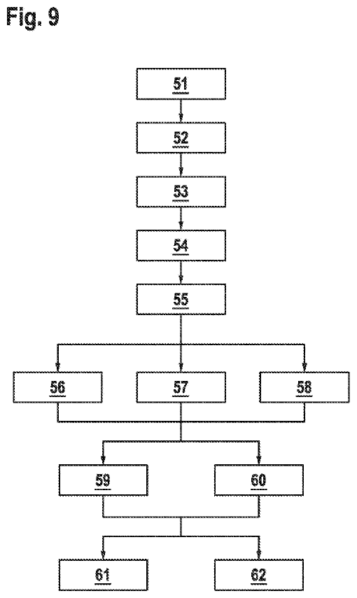

A gas conveying device 22, designed as, e.g., a blower 23 or a compressor 24, conveys air from the environment as an oxidizer into an oxidizer supply line 25. From the supply line 25, the air is supplied to the oxidizer channels 13, which form a channel structure 29 on the bipolar plates 10 for oxidizers such that the oxidizer passes through the gas space 32 for the oxidizer. The gas space 32 for the oxidizer is formed by the channels 13 and the GDL 9 on the cathode 8. After passing through the channels 13 or the gas space 32 for the oxidizer 32, the oxidizer not consumed on the cathode 8 and the reaction water resulting on the cathode 8 due to the electrochemical redox reaction are discharged from the fuel cells 2 through a discharge line 26. A supply line 27 is used to supply coolant into the channels 14 for coolant, and a discharge line 28 is used to discharge coolant conducted through the channels 14. The supply and discharge lines 15, 16, 25, 26, 27, 28 are shown as separate lines in FIG. 1 for the sake of simplicity. They are in fact constructively designed at the end region near the channels 12, 13, 14 as aligned fluid openings 42 on sealing layers 41 at the end region of the membrane electrode assemblies 6 that are arranged on top of each other (FIG. 6). Fluid openings (not shown) are also designed in a similar manner on plate-shaped extensions (not shown) of the bipolar plates 10, and the fluid openings in the plate-shaped extensions of the bipolar plates 10 align with the fluid openings 42 and the sealing layers 41 of the membrane electrode assemblies 6 for partially forming the supply and discharge lines 15, 16, 25, 26, 27, 28. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. An upper clamping plate 35 lies atop the uppermost fuel cell 2, and a lower clamping plate 36 lies atop the lowermost fuel cell 2. The fuel cell unit 1 comprises approximately 200 to 400 fuel cells 2, not all of which are shown in FIG. 4 for illustrative reasons. The clamping elements 33 impart a compression force on the fuel cells 2. In other words, the upper clamping plate 35 imparts a compression force on the uppermost fuel cell 2, and the lower clamping plate 36 imparts a compression force on the lowermost fuel cell 2. The fuel cell stack 2 is thus tensioned in order to ensure the sealing for the fuel, the oxidizer, and the coolant, in particular due to the elastic seal 11, and also to keep the electrical contact resistance within the fuel cell stack 1 as low as possible. To clamp the fuel cells 2 with the clamping elements 33, four connection devices 39 are designed on the fuel cell unit 1 as bolts 40, which are tensioned. The four bolts 40 are fixedly connected to the clamping plates 34.

FIG. 6 shows a perspective view of the membrane electrode assembly 6 of the fuel cell unit 1. The layered membrane electrode assembly 6 comprises a layered inner region 38 from the proton exchange membrane 5. The substantially rectangular proton exchange membrane 5 is completely enclosed and framed by two layered sealing layers 41 as a first subgasket 43 and a second subgasket 44. In the inner region 38, the layered proton exchange membrane 5 is arranged between the layered anode 7 and the layered cathode 8 (not visible due to the perspective view in FIG. 6). The sealing layers 41 and thereby the first and second subgaskets comprise the materials of polyethylene naphthalate (PEN) as a thermoplastic. The layered membrane electrode assembly 6 spans an imaginary plane 37 (FIG. 3). Moreover, the bipolar plates 10 and the anodes 7 and cathodes 8 with the catalyst layers 30 and the gas diffusion layers 9 also span fictitious planes 37 aligned parallel to each other.

For producing the catalyst material 47 comprising catalytically active nanoparticles 47, a provision 51 of a carrier material is performed. The carrier material consists of carbon powder, with a carbon particle size ranging between 20 nm and 40 nm. The carrier material features a high degree of porosity for the attachment or adhesion of a first and a second starting material. The first starting material is also provided 52. The first starting material is a chemical compound as a precursor of a first metal as platinum (Pt) and other chemical elements, e.g., H₂PtCl₆ or Pt(NO₃)₂) in a solution, in particular with alcohol, preferably ethylene glycol. Furthermore, the second starting material is provided 53. The second starting material comprises a second metal, i.e., tungsten (W) or molybdenum (Mo) as an oxide of the second metal as oxide nanoparticles, e.g., WO₃, or a solution of a salt of the second metal or a complex with the second metal, in particular as a solution in alcohol, in particular ethylene glycol, or with alcohol and water. Subsequently, a mixing 54 of the first starting material, the second starting material and the carrier material is performed to form a reactant material such that the first and second starting materials at least partially attach 55 and adhere 55 to the carrier material. A material quantity ratio between the first metal and the second metal from 1:3 to 2:1 is advantageous. After mixing 54 the first and second starting materials and the carrier material with the reactant material, the reactant material is dried, so the reactant material is then present as a powder or particulate reactant material.

Subsequently, a thermal treatment 56 of the reactant material is performed with the first and second starting materials and the carrier material, i.e., they are heated to about 500° C. to 1500° C. for a few hours while being arranged 58 in a hydrogen atmosphere. The temperature level affects the size of the nanoparticles 47. The thermal treatment 56 and the arranging 58 in the hydrogen atmosphere are, e.g., performed in a closed furnace (not shown). The thermal treatment 56 causes the first metal as platinum and the second metal as tungsten or molybdenum to combine into nanoparticles 47 with an alloy of the first and second metal 57 as an intermediate material, i.e., the production 57 of catalytically active nanoparticles 47 is performed with an alloy of the first and second metals. During the thermal treatment, the entire second metal is in this case not typically transferred to the alloy with the first metal, such that the first and/or second starting materials, e.g., as tungsten oxide, WO₃, remain in the catalytically active nanoparticles 47, in particular at the surface 48 and/or surface layer 49. The catalytically active nanoparticles 47 from the alloy attach to the carbon particles of the carrier material as an adhesion. The thermal treatment causes the formation of the nanoparticles 47 as an intermediate material in a solution. The nanoparticles 47 with a diameter of between 1.5 and 4.0 nm comprise a surface 48. In the outer marginal regions of the nanoparticles 47, a surface layer 49 with a layer thickness between 3% and 20% of the diameter of the nanoparticles 47 is formed. Within the surface layer 49, the interior 50 of the nanoparticles 47 exists.

After producing the catalytically active nanoparticles 47 as an intermediate material in the form of a powder, the proportion of the second metal, tungsten, or molybdenum, and/or a tungsten oxide or molybdenum oxide, is reduced 59 in the surface layer 49 by performing a rinse 60 of the intermediate material with sodium hydroxide and alcohol such that a solution is provided during the rinse 60. Sodium hydroxide partially dissolves out tungsten oxide or molybdenum oxide in the surface layer 49, so the remaining proportion of the catalytically active alloy of the first and second metals and the proportion of the first metal as platinum is increased at the surface 48 of the nanoparticles 47 as a solution, and the catalytic effect of the catalyst material 47 as the nanoparticles 47 is also greatly increased as a result, thereby producing a product material. Alcohol in the solution improves dispersion during the rinse 60.

Subsequently, an additional thermal treatment 61 of the product material with the catalytically active nanoparticles 47 as the catalyst layer 30 is performed, i.e., it is heated to about 200° C. to 700° C. for a few hours while being arranged 62 in a hydrogen atmosphere. During or prior to the additional thermal treatment 61, the product material as a solution is dried into a powder or particulate product material without a liquid. In the surface layer 49 of the nanoparticles 47, the composition between platinum and tungsten is between 95%:5% and 60%:40%.

To produce catalyst layers 30, in particular, electrodes 7, 8, 45 with catalyst layers 30 for fuel cells 2, the following steps are performed: providing catalyst material 47 according to the description hereinabove comprising catalytically active nanoparticles 47, providing carrier layers 46 for adhesion of catalyst material 47, applying the catalyst material 47 to the carrier layers 46, such that the catalyst material 47 is adhesively adhered to the carrier layers 46 and made from the carrier layers 46 of the catalyst layers 30. The catalyst material 47 acting as the product material is present as a dry powder or dry particles, such that the dry, powdered or particulate product material is mixed into a slurry with water, alcohol and at least one ionomer, e.g., Nafion®, before it is applied to the carrier layer. This slurry is subsequently wet-chemically applied to the carrier layer 46—e.g., an electrode 7, 8, 45 or a gas diffusion layer 9—in a thin layer, e.g., with a layer thickness of 10 μm. The slurry as a product material attaches or adheres wet-chemically to the carrier layer 46, such that a catalyst layer 30 is formed on the adjacent area of the carrier layer 46. Drying of the catalyst layer 30 is preferably then performed.

Overall, significant advantages are associated with the method of producing catalyst material 47 according to the invention, the method of producing catalyst layers 30 according to the invention, the fuel cell unit 1 according to the invention, and the method of producing the fuel cell unit 1 according to the invention. The catalytically active nanoparticles 47 in the catalyst layers 30 of the carrier layers 46 contain a high proportion of platinum and/or the alloy of platinum and tungsten or molybdenum and a low proportion of tungsten oxide or molybdenum oxide in the surface layers 49, such that the fuel cells 2 achieve a high electrical performance per unit area, e.g., cm². This represents a particularly important advantage in the application of the fuel cell unit 1 in motor vehicles.

1. A method for producing a catalyst material (47) comprising catalytically active nanoparticles (47), the method comprising the steps of:
providing (52) a first starting material comprising a first metal,
providing (53) a second starting material comprising a second metal,
mixing the first starting material and the second starting material to form a reactant material, and
thermally treating (56) the reactant material so that catalytically active nanoparticles (47) are produced from the first starting material and the second starting material, and the first and second metal are connected together in order to at least partly form an alloy of the first and second metals in the catalytically active nanoparticles (47) such that catalytically active nanoparticles (47) are produced as an intermediate material comprising the alloy of the first and second metals,
wherein
in the intermediate material, content of the second metal and/or the second starting material on a surface (48) of the catalytically active nanoparticles (47) is reduced so that a product material is produced from the intermediate material as the catalyst material (47).

2. The method according to claim 1,
wherein
on the surface (48) of the catalytically active nanoparticles (47), a proportion of the second metal and/or of the second starting material is reduced with a fluid by rinsing (60) the intermediate material with the fluid so that the second metal and/or the second starting material is taken up in the fluid and is removed from the intermediate material as a result of a flow of the fluid.

3. The method according to claim 2,
wherein
a pH level of the fluid is greater than 7, 9, or 11.

4. The method according to claim 2,
wherein
the fluid comprises sodium hydroxide, and/or potassium hydroxide, and/or ammonia, and/or tetramethyl ammonium hydroxide, and/or alcohol, and/or water.

5. The method according to claim 1,
wherein
on the surface (48) of the catalytically active nanoparticles (47), a proportion of the second metal and/or the second starting material is reduced by at least 20%, 30%, 50%, 70%, or 90%.

6. The method according to claim 1,
wherein
after the thermal treatment (56) of the intermediate material, following the production of the catalytically active nanoparticles (47), and while proportions of the second metal and/or of the second starting material on the surface (48) of the catalytically active nanoparticles (47) are reduced, the proportion of the second metal and/or of the second starting material is maintained at substantially constant levels in an interior (50) of the catalytically active nanoparticles (47).

7. The method according to claim 1,
wherein
the product material is subjected to an additional thermal treatment (61) after proportions of the second metal and/or the second starting material on the surface (48) of the catalytically active nanoparticles (47) have been reduced.

8. The method according to claim 7,
wherein
during the additional thermal treatment (61), the product material having the catalytically active nanoparticles (47) is at a temperature between 100° C. and 1200° C.

9. The method according to claim 7,
wherein
during the additional thermal treatment (61), the product material having the catalytically active nanoparticles (47) is exposed (62) to a process gas.

10. The method according to claim 1,
wherein
the first starting material comprises a chemical compound as a precursor with the first metal and at least one chemical element.

11. The method according to claim 1,
wherein
the second starting material includes metal oxide nanoparticles from a compound between a second metal and oxygen, as a solution with the metal oxide nanoparticles,
and/or
as a solution with a salt with the second metal,
and/or
as a solution configured as a complex with the second metal.

12. The method according to claim 1,
wherein
the first metal is a noble metal, and/or
the second metal is a transition metal.

13. A method for producing catalyst layers (30), the method comprising the steps of:
providing catalyst material (47) comprising catalytically acting nanoparticles (47),
providing carrier layers (46) for adhesion of catalyst material (47),
applying the catalyst material (47) to the carrier layers (46), such that the catalyst material (47) is adhered to the carrier layers (46) and made from the carrier layers (46) of the catalyst layers (30),
wherein
the catalyst material (47) is provided by performing a method according to claim 1.

14. A fuel cell unit (1) as a fuel cell stack for electrochemically generating electrical energy, comprising fuel cells (2) arranged as stacks, the fuel cells (2) each comprising
a proton exchange membrane (5),
an anode (7, 45),
a cathode (8, 45), wherein the anode (7, 45) and/or cathode (8, 45) each comprises a catalyst layer (30) with catalytically active nanoparticles (47) with an alloy of a first and second metal,
a bipolar plate (10), and
gas diffusion layers (9),
wherein
on a surface (48) of the catalytically active nanoparticles (47), a proportion of the second metal and/or a second starting material is greater than in an interior (50) of the nanoparticles (47).

15. A method for producing a fuel cell unit (1) as a fuel cell stack (1) for electrochemically generating electrical energy, having the steps of:
providing components (5, 6, 7, 8, 9, 10) of the fuel cells (2), including anodes (7, 45) and/or cathodes (8, 45), each comprising a catalyst layer (30) with catalytically active nanoparticles (47) with an alloy of a first and second metal,
connecting the components (5, 6, 7, 8, 9, 10) of the fuel cells (2) to the fuel cells (2),
stacking the fuel cells (2) such that a fuel cell unit (1) is formed,
wherein
the catalyst layers (30) are provided by performing a method according to claim 13, and
on the surface (48) of the catalytically active nanoparticles (47), a proportion of the second metal and/or the second starting material is greater than in an interior (50) of the nanoparticles (47).

16. The method according to claim 1, wherein the catalyst material (47) comprising catalytically active nanoparticles (47) is for electrodes (7, 8, 45) with catalyst layers (30) as catalysts for a fuel cell (2).

17. The method according to claim 2, wherein the fluid is a liquid and the second metal and/or the second starting material is dissolved in the fluid.

18. The method according to claim 8, wherein during the additional thermal treatment (61), the product material having the catalytically active nanoparticles (47) is at a temperature between 200° C. and 800° C.

19. The method according to claim 10, wherein the at least one chemical element includes hydrogen and/or oxygen and/or nitrogen and/or chlorine.

20. The method according to claim 12, wherein the first metal includes palladium (Pd), and/or platinum (Pt) and/or rhodium (Rh) and/or ruthenium (Ru) and/or iridium (Ir) and/or osmium (Os), and/or
the second metal includes chromium (Cr), and/or molybdenum (Mo), and/or tungsten (W).
